(19) United States
(12) Patent Application Publication
(10) Pub. No.: US 2025/0041797 A1
(43) Pub. Date: Feb. 6, 2025

(54) CALCIUM HYDROXIDE COMPOSITION AND CARBON REMOVAL IN AIR USING THE SAME

(71) Applicants: Johan BRANDT, Nandrin (BE); Manoeli SANTANA DE OLIVEIRA DA SILVA, Watermael-Boisfort (BE); Aurélien CHARDON, Namur (BE); Nassim BOUCHOUL, Hemptinne (BE); Pierre-Olivier CAMBIER, Hamme-Mille (BE)

(72) Inventors: Johan BRANDT, Nandrin (BE); Manoeli SANTANA DE OLIVEIRA DA SILVA, Watermael-Boisfort (BE); Aurélien CHARDON, Namur (BE); Nassim BOUCHOUL, Hemptinne (BE); Pierre-Olivier CAMBIER, Hamme-Mille (BE)

(21) Appl. No.: 18/770,235

(22) Filed: Jul. 11, 2024

(30) Foreign Application Priority Data
Jul. 13, 2023 (EP) 23185150.2

(51) Int. Cl. B01D 53/62; B01D 53/34; B01D 53/78; B01D 53/82; B01D 53/83

(52) U.S. Cl. CPC B01D 53/62; B01D 53/346; B01D 53/78; B01D 53/82; B01D 53/83; B01D 2251/404; B01D 2251/604; B01D 2257/504; B01D 2258/06

(57) ABSTRACT

A process for direct capture of carbon dioxide in air may include contacting a calcium hydroxide-based composition with air so as to capture CO₂ contained in the air by transforming at least some of the calcium hydroxide of the composition into calcium carbonate. A calcium carbonate-based composition is formed and collected. At least some CO₂ from the collected calcium carbonate-based composition is extracted, preferably via calcination and/or electrolysis. The calcium hydroxide-based composition has a partial pore volume equal to or higher than 0.09 cm³/g for a range of pores having a diameter between 20 and 200 Å.

### FIELD

This disclosure relates to systems and methods for direct capture of carbon dioxide in air and calcium hydroxide-based compositions.

### Introduction

CO₂ emissions linked to human activities are recognized as being responsible for climate change. Although efforts are being made to decrease the quantity of CO₂ released into the atmosphere, there is a growing consensus that decreasing emissions alone will not be sufficient to avoid global temperature increase of more than 1.5° C. compared to pre-industrial era.

There is therefore a need to deploy techniques capable of removing CO₂ from the atmosphere. Such techniques are often designated under the generic term carbon dioxide removal technologies (CDR technologies), which includes for instance afforestation, bio-energy with carbon capture and storage (BECCS) and Direct Air Capture (DAC). These technologies can help in capturing and/or storing up to 10 billion tons of CO₂ per year by 2050 and are thus recognized as essential means to achieve carbon neutrality.

Direct Air Capture refers to CDR approaches that rely on chemicals that react with atmospheric CO₂ and followed by a subsequent step aimed at separating the chemicals and the CO₂ in a substantially pure form so that it is compatible with sequestration or use.

Several technological routes have been proposed for DAC and some have reached or are close to reach commercial maturity. However, they come with several techno-economic challenges, such as:
Use of large and relatively engineered equipment to ensure efficient contact between the chemicals with strongly-diluted atmospheric CO₂;
Need for electricity to run fans to blow air and pumps for transporting the chemicals in liquid form;
Need for thermal energy to separate the chemicals and the CO₂;
Cost and complexity in manufacturing reacting material;
Water loss linked to the evaporation of the water from the aqueous solution containing the reacting chemical;
Upscaling of the technique to cater high demand of CDR;
Minimizing the use of the natural resources (such as water, as mentioned above, but also all the other components used in the process).
Sensitivity of the DAC process to local weather conditions

Therefore, there is thus a need for DAC system with reduced capital and operational cost that uses cheap and widely available raw materials to ensure cost efficiency and scalability.

In this regard, quicklime (alternatively hydrated lime) produced from a source of calcium carbonate such as natural limestone, can be used for capturing CO₂ according to the following reaction:

CaO+CO₂->CaCO₃ (Equation 1)

alternatively

Ca(OH)₂+CO₂->CaCO₃+H₂O (Equation 2)

The formed carbonate can then be calcined again to produce lime and substantially pure CO₂ for use or sequestration:

CaCO₃+heat->CaO+CO₂ (Equation 3)

The heat necessary for the calcination can be provided by the combustion of fuel. For instance, industrial oxygen can be advantageously used instead of air in order to avoid dilution of the CO₂ with nitrogen from the air.

After a purification step, both the CO₂ resulting from the decomposition of calcium carbonate and from the combustion of fuel can be sequestered, resulting in net removal of CO₂ from the atmosphere.

The produced lime or hydrated lime can then be re-exposed to atmospheric air for subsequent CO₂ capture.

Hydrated lime Ca(OH)₂ has some advantages compared to quicklime CaO due to its microstructural properties that enable faster and higher conversion of lime to carbonate. Relative humidity has also been identified as n results from a dissolution-precipitation mechanism. For instance N. Koga et al./Ceramics International 41 (2015) 9482-9487 al. reported that no carbonation reaction occurs at 0% relative humidity. More interestingly, it was highlighted that conversion rate plateaued at 40% conversion to CaCO₃ when relative humidity was 50%.

The ability of the sorbent to achieve high conversion to carbonate is indeed important to minimize the amount of sorbent required to capture a given quantity of CO₂. Moreover, unreacted calcium hydroxides induces an energy penalty during the calcination step:
The standard enthalpy of calcination of CaCO₃ is 178 kJ/mol.

The standard enthalpy of de-hydration of Ca(OH)₂ is 65 kJ/mol. It should be noted that for each mol of de-hydrated Ca(OH)₂ 1 mol of H₂O remains as steam (i.e., latent heat of vaporization is not recovered), therefore increasing the dehydration enthalpy to about 65+2,256 kJ/g*18 g/mol=106 kJ/mol.

### SUMMARY

The present disclosure aims to provide a solution to overcome at least one drawback of the teaching provided by the prior art document.

In particular the present disclosure aims to provide a direct air capture process or sorbents capable of achieving a high conversion ratio, preferably under different types of weather conditions, particularly under arid conditions.

For the above purpose, the present disclosure is directed to a process for direct capture of carbon dioxide in air comprising a process for direct capture of carbon dioxide in air comprising the following steps: providing a calcium hydroxide-based composition; contacting said composition with air so as to capture CO₂ contained in said air by transforming at least some of the calcium hydroxide of said composition into calcium carbonate, forming a calcium carbonate-based composition; optionally collecting the calcium carbonate-based composition; optionally extracting at least some CO₂ from at least some of the collected calcium carbonate-based composition, preferably via calcination and/or electrolysis, wherein said calcium hydroxide-based composition has a partial pore volume equal to or higher than 0.09 cm³/g, in particular higher than 0.1 cm³/g, said partial pore volume being calculated according to the BJH method for a range of pores having a diameter between 20 and 200 Å in accordance with standard DIN 66134 (February 1998 version); optionally the difference between a total pore volume being calculated according to the BJH method for a range of pores having a diameter of between 20 and 1000 Å in accordance with standard DIN 66134 (February 1998 version) and said partial pore volume being equal to or higher than 0.06 cm³/g, preferably higher than 0.08 cm³/g.

According to specific embodiments of the present disclosure, the process for direct capture of carbon dioxide in air comprises one or more of the following features/steps:
mixing a calcium hydroxide-based powder composition with water and optionally a first additive in order to obtain a composition with a water content above 35% by weight of said composition, and optionally at most 85% by weight of said composition;
slaking quicklime, possibly partly hydrated, optionally in presence of a second additive in order to obtain a composition with a water content above 35% by weight of said composition, and optionally at most 85% by weight of said composition;
said composition being a flowable composition, such as a putty lime or a milk of lime;
providing the calcium hydroxide-based composition comprises providing the flowable composition, optionally applying said composition on a support to form a layer, in particular forming ridges on said layer;
shaping the flowable composition into shaped bodies, in particular 3D printings or extrudate, thereby forming the calcium hydroxide-based composition, preferably forming ridges on the shaped bodies, notably curing said shaped bodies with CO₂;
said shaped bodies having at least one dimension greater than 3 mm;
prior to the shaping of the shaped bodies, mixing the flowable composition with at least one element selected from the group comprising structural elements, such as woven or non-woven fibers, at least one additive, water, or any combination thereof, preferably the at least one additive being selected from the group comprising shaping additive, pore-forming agent, compressive strength enhancer such as cementitious material, additives to increase particle size such as gypsum and air entraining agent;
shaping a calcium hydroxide-based powder composition into shaped bodies, in particular pellets, granules, extrudates, 3D printings or compacts such as tablets or briquettes, thereby forming the calcium hydroxide-based composition, preferably forming ridges on the shaped bodies, notably curing said shaped bodies with CO₂, preferably said shaped bodies having at least one dimension greater than 3 mm;
mixing a calcium hydroxide powder with at least one element selected from the group comprising structural elements such as woven or non-woven fibers, at least one additive, water, or any combination thereof, thereby forming the calcium hydroxide-based powder composition, preferably the at least one additive being selected from the group comprising shaping additive, pore-forming agent, compressive strength enhancer such as cementitious material, additives to increase particle size such as gypsum and air entraining agent;
the supply of the calcium hydroxide-based composition comprises the supply of the shaped bodies;
the supply of the calcium hydroxide-based composition comprises the supply of a calcium hydroxide-based composition with water lower than or equal to 35% by weight of said composition, preferably at most 20% by weight, more preferably at most 15% by weight of said composition, and/or at least 5% by weight, preferably at least 10% by weight of said composition;
the collection of the calcium carbonate-based composition takes place when said composition reaches a CO₂ content of at least 31%, preferably at least 33%, in particular at least 37% by weight on a dry basis;
a step of providing a support for the calcium hydroxide-based composition, said support being stationary or in motion relative to a reference frame.
the support is selected from the group comprising trommel, plate, such as corrugated plate, bucket, pile, shelf, tray, filter media, cartridge, grate, tile, walls, brick, carbonated product, net, ground, basket and gabion.
the support is selected from the group comprising trommel, plate, such as corrugated plate, bucket, pile, shelf tray, filter media, such as clothes or bags in a bag filter, cartridge, grate, tile, wall, brick, carbonated product ground and net;
flowing air through the filter media, such as clothes or bags in a bag filter, comprising the calcium hydroxide-based composition;
the support is selected from the group comprising plate, such as corrugated plate, bucket, pile, shelf, tray, filter media, such as clothes or bags in a bag filter, cartridge, grate, tile, wall, brick, bead, carbonated product, ground and net;
applying said composition on the support to form a layer
forming ridges on said layer;
the step of contacting the calcium hydroxide-based composition with air in a packed bed such as a fixed bed or a moving bed or in a fluidized bed such as a bubbling bed, a spouted bed, a circulating fluidized bed or an entrained bed;
the step of contacting the calcium hydroxide-based composition with said air further comprising adjusting at least one of: an air flow rate, a calcium hydroxide-based composition flow rate, a calcium hydroxide-based composition residence time, a calcium hydroxide-based composition inventory, an air temperature, an air relative humidity, an air absolute humidity, and/or an absolute water content inside the calcium hydroxide-based composition, with at least one control means for controlling the CO₂ capture in air comprising at least one of: one or more air flow control elements, such as valve, guiding blade, fan or blower, Calcium hydroxide-based composition flow control elements, a humidifier, cooler, and/or heater;
providing an air flow inlet arranged upstream from the calcium hydroxide-based composition and/or an air flow outlet arranged downstream from the calcium hydroxide-based composition;
the step of adjusting comprises adjusting as a function of at least one of: weather conditions, in particular an ambient air temperature and/or an air relative humidity as measured or estimated at the air flow inlet, the CO₂ content in said composition at one or more locations, and/or the difference in CO₂ concentration between the air flow inlet and outlet;
the step of contacting said composition with said air, the calcium hydroxide-based composition is exposed to air having temperatures falling in the range from 2° C. to 50° C., preferably in the range from 15° C. to 50° C. and/or relative humidity levels falling in the range from 10% to 95%, more preferably in the range from 10% to 80%, in particular in the range from 10% to 50% or 40% to 80%;
conditioning the collected calcium carbonate-based composition prior to the step of extracting at least some CO₂ from at least some of the collected calcium carbonate-based composition, preferably the step of conditioning comprising at least one of drying, grinding, milling, classifying, dehydroxylating or purifying the collected calcium carbonate-based composition, or any combination thereof, in particular the step of purifying comprising separating at least some of the unreacted calcium hydroxide from the collected calcium carbonate-based composition, for instance via at least one of the following purification processes: air classification, leaching, pealing or floatation, or any combination thereof;
capturing at least a part of the CO₂ formed during the step of extracting at least some CO₂ from at least some of the collected calcium carbonate-based composition for subsequent sequestration and/or use.

The present disclosure can also be related to a calcium hydroxide-based composition characterized by a partial pore volume equal to or higher than 0.09 cm³/g, in particular higher than 0.1 cm³/g, said pore volume being calculated according to the BJH method for a range of pores having a diameter between 20 and 200 Å in accordance with standard DIN 66134 (February 1998 version); preferably a BET specific surface area greater than 30 m²/g, preferably greater than 40 m²/g, and more preferably greater than 45 m²/g measured according to IS09277 standard (September 2010 version); preferably a BET specific surface area greater than 30 m²/g, preferably greater than 40 m²/g, and more preferably greater than 45 m²/g measured according to IS09277 standard (September 2010 version; wherein said composition (is in the form of a composition with) has a water content above 35% by weight of said composition, preferably at most 85% by weight of at least of said composition, preferably said composition being a flowable or malleable composition such as a milk of lime or putty lime; optionally the difference between a total pore volume being calculated according to the BJH method for a range of pores having a diameter of between 20 and 1000 Å in accordance with standard DIN 66134 (February 1998 version) and said partial pore volume being equal to or higher than 0.06 cm³/g, preferably higher than 0.08 cm³/g.

The present disclosure can also be related to a calcium hydroxide-based composition characterized by: a partial pore volume equal to or higher than 0.09 cm³/g, in particular higher than 0.1 cm³/g said pore volume being calculated according to the BJH method for a range of pores having a diameter of between 20 and 200 Å in accordance with standard DIN 66134 (February 1998 version); preferably a BET specific surface area greater than 30 m²/g, preferably greater than 40 m²/g, and more preferably greater than 45 m²/g measured according to IS09277 standard (September 2010 version); optionally wherein the difference between a total pore volume being calculated according to the BJH method for a range of pores having a diameter of between 20 and 1000 Å in accordance with standard DIN 66134 (February 1998 version) and said partial pore volume is equal to or higher than 0.06 cm³/g, preferably higher than 0.08 cm³/g; wherein said composition is in the form of shaped bodies, wherein the shaped bodies are selected from the group comprising pellets, granules, extrudates, 3D printings or compacts such as tablets or briquettes, preferably said composition having an apparent density lower than 1.4 g/cm³, and optionally lower than 1.1 g/cm³ and preferably higher than 0.8 g/cm³.

The present disclosure can also be related to a calcium hydroxide-based powder composition, said composition having a partial pore volume equal to or higher than 0.09 cm³/g, said pore volume being calculated according to the BJH method for a range of pores having a diameter of between 20 and 200 Å in accordance with standard DIN 66134 (February 1998 version); preferably a BET specific surface area greater than 30 m²/g, preferably greater than 40 m²/g, and more preferably greater than 45 m²/g measured according to IS09277 standard (September 2010 version); optionally wherein the difference between a total pore volume being calculated according to the BJH method for a range of pores having a diameter of between 20 and 1000 Å in accordance with standard DIN 66134 (February 1998 version) and said partial pore volume is equal to or higher than 0.06 cm³/g, preferably higher than 0.08 cm³/g; a weight fraction of Ca(OH)₂ of at least 80%, preferably at least 90% on a dry basis; wherein said composition reaches a CO₂ content of at least 31% by weight, preferably at least 33% by weight, more preferably at least 37% by weight, in particular at least 41% by weight on a dry basis when carbonated under a test where four samples, namely a first, second, third and fourth sample of said composition are in contact with four predefined CO₂ enriched air compositions adapted to simulate an accelerated carbonatation in a weathering chamber, said the CO₂ content being the lowest of the four CO₂ contents measured under the following conditions:
the first sample being in contact with CO₂ enriched air with a target temperature of 10° C., a target relative humidity of 75% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value;
the second sample being in contact with CO₂ enriched air with a target temperature of 30° C., a target relative humidity of 75% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value;
the third sample being in contact with CO₂ enriched air with a target temperature of 30° C., a target relative humidity of 60% and a target CO₂ concentration of 2000 ppmv, for 200 hours, wherein the temperature, the relative humidity and CO₂ content are regulated to remain in the range of +/−0.7° C., +/−5% RH and +/−10% around their corresponding target value;
the fourth sample in contact with CO₂ enriched air with a target temperature of 30° C., a target relative humidity of 45% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value.

According to specific embodiments of the present disclosure, the calcium hydroxide-based composition comprises one or more of the following features/steps:
a water content lower than or equal to 35% by weight of said composition, preferably at most 20% by weight, more preferably at most 15% by weight, and/or at least 5% by weight, preferably at least 10% by weight;
said composition reaches a CO₂ content of at least 31% by weight, preferably at least 33% by weight, more preferably at least 37% by weight, in particular at least 41% by weight on a dry basis when carbonated under a test where four samples, namely a first, second, third and fourth sample of said composition are in contact with four predefined CO₂ enriched air compositions adapted to simulate an accelerated carbonatation in a weathering chamber, said the CO₂ content being the lowest of the four CO₂ contents measured under the following conditions:
   the first sample being in contact with CO₂ enriched air with a target temperature of 10° C., a target relative humidity of 75% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value;
   the second sample being in contact with CO₂ enriched air with a target temperature of 30° C., a target relative humidity of 75% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value;
   the third sample being in contact with CO₂ enriched air with a target temperature of 30° C., a target relative humidity of 60% and a target CO₂ concentration of 2000 ppmv, for 200 hours, wherein the temperature, the relative humidity and CO₂ content are regulated to remain in the range of +/−0.7° C., +/−5% RH and +/−10% around their corresponding target value;
   the fourth sample in contact with CO₂ enriched air with a target temperature of 30° C., a target relative humidity of 45% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value;
each sample prior to the accelerated carbonatation is milled to an average particle diameter less than 250 μm;
wherein each sample prior to the accelerated carbonatation is dried to reach a water content less than 1% by weight;
a weight fraction of Ca(OH)₂ of at least 80%, preferably at least 90% on a dry basis.

According to specific embodiments of the present disclosure, the calcium hydroxide-based powder composition comprises one or more of the following features:
A particle diameter average of the calcium hydroxide-based powder composition is less than 100 μm, preferably less than 10 μm
a water content lower than or equal to 35% by weight of said composition, preferably at most 20% by weight, more preferably at most 15% by weight, and/or at least 5% by weight, preferably at least 10% by weight;
   Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

Aspects of the present disclosure will now be described in more detail with reference to the appended drawings, wherein same reference numerals illustrate the same features.

FIG. 1 shows a direct air capture process using baskets filled with sorbent shaped bodies, disposed on a shelf according to an embodiment of the present disclosure.

FIG. 2 shows a direct air capture process using beads coated with sorbents according to another embodiment of the present disclosure.

FIG. 3 shows a direct air capture process using gabions filled with sorbent shaped bodies

FIG. 4 shows a direct air capture process where sorbent is injected in an air flow and collected and contacted with the air for a certain time by using a filter media according to an embodiment of the present disclosure.

FIG. 5 shows a direct air capture process using two rows of gabions filled with sorbent shaped bodies, arranged in multiple layers, said rows being integrated into an air conditioning structure according to another embodiment of the present disclosure.

FIG. 6 shows a direct air capture process using baskets filled with sorbent shaped bodies, disposed on shelves integrated into an air conditioning structure according to another embodiment of the present disclosure.

FIG. 7 shows a direct air capture process using gabions filled with sorbent shaped bodies integrated in an air conditioning structure, including a humidifier according to another embodiment of the present disclosure.

FIG. 8 discloses a comparison of molar conversions of calcium hydroxide compositions tested under four different simulated climatic conditions, namely Test A (CO₂: 2000 ppmv, 10° C. and 75% RH), Test B (CO₂: 2000 ppmv, 30° C. and 75% RH), Test C (CO₂: 2000 ppmv, 30° C. and 60% RH) and Test D (CO₂: 2000 ppmv, 30° C. and 45% RH).

FIGS. 9A, 9B, 9C and 9D disclose a comparison of molar conversions of the calcium hydroxide compositions under Test C (30° C. and 60% RH) as a function of the microstructure characteristics (BET specific surface area, BJH 20-1000 Å, BJH 20-100 Å, BJH 20-100 Å).

FIG. 10 shows molar conversion evolution over time of the calcium hydroxide compositions under Test A (CO₂: 2000 ppmv, 10° C. and 75% RH).

FIG. 11 shows molar conversion evolution over time of the calcium hydroxide compositions under Test B (CO₂: 2000 ppmv, 30° C. and 75% RH).

FIGS. 12A and 12B show a comparison of molar conversion of the calcium hydroxide compositions under Test B (CO₂: 2000 ppmv, 30° C. and 75% RH) as function of the BET specific surface area, BJH 200-1000 Å.

FIG. 13 shows a molar conversion evolution over time of the calcium hydroxide compositions under Test C (CO₂: 2000 ppmv, 30° C. and 60% RH).

FIG. 14 shows a molar conversion evolution over time of the calcium hydroxide compositions under Test D (CO₂: 2000 ppmv, 30° C. and 45% RH).

FIG. 15 shows a molar conversion evolution over time of the calcium hydroxide compositions under ambient condition (average CO₂ concentration ˜455 ppmv, average temperature: 10.5° C., average relative humidity: 63%).

### DETAILED DESCRIPTION

The present disclosure will now be described more fully hereinafter with reference to the accompanying drawings. The present disclosure may however be embodied in many different forms and should not be construed as limited to the embodiments set forth herein; rather, these embodiments are provided for thoroughness and completeness.

For the process for direct capture of carbon dioxide in air according to the present disclosure, a calcium hydroxide-based composition is provided with a partial pore volume equal to or higher than 0.09 cm³/g, in particular higher than 0.1 cm³/g, said partial pore volume being calculated according to the BJH method for a range of pores having a diameter between 20 and 200 Å in accordance with standard DIN 66134 (February 1998 version); optionally the difference between a total pore volume being calculated according to the BJH method for a range of pores having a diameter of between 20 and 1000 Å in accordance with standard DIN 66134 (February 1998 version) and said partial pore volume being equal to or higher than 0.06 cm³/g, preferably higher than 0.08 cm³/g.

More specifically, the calcium hydroxide-based calcium composition is obtained with the following preparation steps:
a) Providing lime particles with an available CaO of greater than 80%, preferably greater than 93% by weight relative to the total weight. By available CaO content (determined in accordance with EN 459-2, paragraph 6.9, (version of July 2021)), it is meant the content contained in the quicklime, and optionally in the hydrate in the event that slight hydration of lime occurs prior to hydration. This content does not include the CaO contained in the carbonate (CaCO₃) and in the sulfate (CaSO₄) which are not effective for the subsequent capture of CO₂ in air. The lime particles also have a sulfur content that is as low as possible, namely below 0.2% and preferably between 0.01 and 0.07% by weight. The MgO content thereof is lower than 8%, and preferably lower than 3% and even 2% by weight, and the CO₂ content is 1.5 weight % or lower. As is conventional, the lime may also contain impurities such as aluminum oxide, iron, manganese or silicon. The lime particles typically have a particle size distribution of between 0 and 3 mm, O and 10 mm, 2 and 10 mm or 5 and 25 mm. The lime can also be milled lime of micrometric size, for example having a particle size distribution of between 0 and 100 μm. Preferably, the lime particles has a T60 greater than 50 s, preferably greater than 60 s, and particularly preferably greater than 100 s, the T60 being measured according to the EN459-2 standard, paragraph 7.6 (version of July 2021).
b) Hydration is performed with a water/lime weight ratio of between 0.6 and 3 or above 3 and preferably between 0.6 and 2, preferably between 0.6 and 1.2, in particular 1 and 1.05, to obtain a mixture having residual humidity of 10% by weight or higher and preferably between 20% to 85% by weight, in particular 25% and 30% by weight. Typically, the temperature of the water is between 1° and 40° C. Hydration is performed in the presence of a hydration-delaying additive comprising at least one hydroxyl chemical function (—O—H) and/or (NHₓ, with x=1,2 or 4) in a proportion of at least 0.4 weight % relative to the lime fed into the hydrator. Preferably, the content of additive is between 0.5 and 5 weight %, but for reasons of economy it is rather more limited to a range of 0.5 to 4.5 weight %, further preferably 0.5 to 3.5 weight %, even 0.5 to 2.5% or even between 0.5 and 1.5 weight %. The additive is selected from the non-exhaustive list comprising ethylene glycol, diethylene glycol, triethylene glycol, monoethanolamine, diethanolamine, triethanolamine, monopropylene glycol, dipropylene glycol, the mixtures and derivative products thereof.
c) optionally drying said mixture to form a dried hydrate mixture having a residual moisture of at least 5%, preferably at least 7% by weight relative to the total weight of said mixture.

The calcium hydroxide-based composition can be provided in the form of a malleable or flowable composition, shaped bodies or powders.

A malleable or flowable composition can be obtained via the above-mentioned preparation directly or indirectly.

In the case of a direct preparation, the malleable or flowable composition is the result of a slaking with a water/lime weight ratio above 1.21 without further dilution or a water/lime weight ratio between 0.75 and 1.2 followed by a dilution. The slaking can be combined with one or more additives.

In the case of an indirect preparation, the malleable or flowable composition is prepared via mixing a dried calcium hydroxide-based powder composition obtained with water/lime weight ratio of between 0.75 and 1.2. The mixing can be combined with one or more additives. The resulting malleable or flowable composition obtained via the slaking or mixing has typically a water content above 35% by weight of said composition, and optionally at most 85% by weight of said composition. A flowable or malleable composition can be a putty lime or a milk of lime.

The malleable or flowable composition can be used as a sorbent to be carbonated in a contactor or as a precursor for a sorbent shaped body. In the latter case, the malleable or flowable composition can be shaped into 3D printings or pellets or other forms obtained by extrusion (e.g. WO1999061373A1). Preferably, the shaped bodies obtained have at least one dimension greater than 3 mm. Preferably a given shaped body has an apparent density lower than 1.4 g/cm³, preferably lower than 1.1 g/cm³ and preferably higher than 0.8 g/cm³. The apparent density characterizes the pore porosity within the particles forming the shaped body but also the intraparticle void volume between the same particles. The intraparticle void volume promotes gas diffusion from the envelope of the shaped body to the pores of the particles forming said shaped body. Optionally, the shaped bodies can be contacted with air or a CO₂ rich atmosphere so as to pre-carbonate them and therefore enhance their mechanical strength. Prior to the shaping of the shaped bodies, the malleable or flowable composition can be mixed with at least one element selected from the group comprising support particles, at least one shaping additive, water, or any combination thereof.

A calcium hydroxide-based powder composition obtained with the above-mentioned process with water/lime weight ratio of between 0.6 and 1.2 can directly applied on a contactor surface or be used a precursor for forming shaped bodies. In the latter case, a calcium hydroxide-based powder composition is shaped into pellets, granules, extrudates, 3D printings or compacts such as tablets or briquettes, preferably said shaped bodies having at least one dimension greater than 3 mm. Examples of shaping devices for calcium-based particulates are disclosed in WO2021078878A1, WO2016110572A1, WO2018007634A1, WO2018007630A1. Eventually, the shaped bodies can be contacted with air or a CO₂-containing atmosphere so as to pre-carbonate them and therefore enhance their mechanical strength. Advantageously, prior to the shaping the calcium hydroxide powder composition is mixed with at least one element selected from the group comprising support particles, at least one shaping additive, water, or any combination thereof. Preferably a given shape body has an apparent density lower than 1.4 g/cm³, preferably lower than 1.1 g/cm³ and preferably higher than 0.8 g/cm³. The apparent density characterizes the pore porosity within the particles forming the shaped body but also the intraparticle void volume between the same particles. The intraparticle void volume promotes gas diffusion from the envelope of the shaped body to the pores of the particles forming said shaped body.

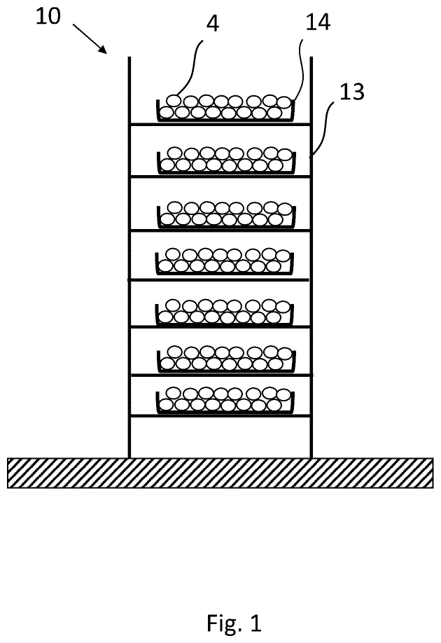

FIG. 1 shows a contactor 10 in the form of a shelf 13 with baskets 14 according to an embodiment of the present disclosure. The baskets 14 contain shaped bodies 4 of calcium hydroxide-based material that are exposed to natural air flow.

Typically, a malleable or flowable composition, such as a milk of lime can be used as a coating precursor. The milk of lime is, for this purpose, applied a on a support surface. For instance, the support surface, such as a plate is immersed in a receptacle containing a milk of lime before being extracted thereof. Over time, the malleable or flowable layer will dry and form an adhering layer on the support surface. The calcium hydroxide composition in the layer will carbonate in contact with the CO₂ present in the air.

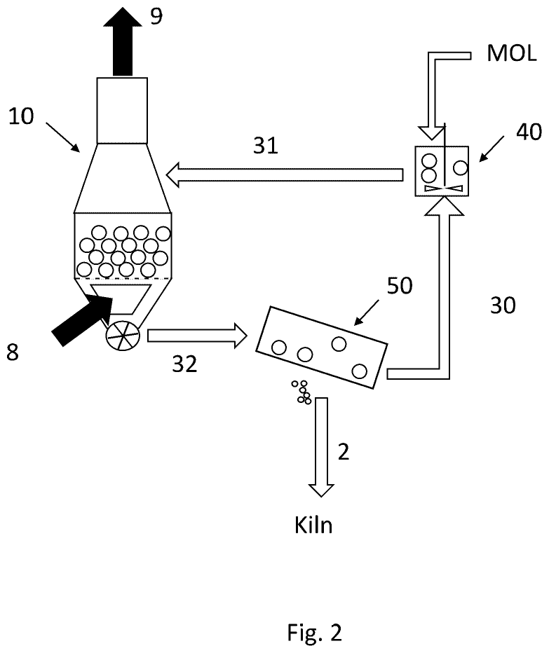

For instance, FIG. 2 shows a direct air capture process using beads coated with sorbents according to a further embodiment of the present disclosure. The beads are immersed in a bath 40 of milk of lime MOL according to the present disclosure. The coated beads 31 are then dried, forming a calcium hydroxide outer layer. A contactor 10 is adapted to receive beads coated with calcium hydroxide sorbent 31. Within the contactor 10, the calcium hydroxide layer undergoes carbonatation upon contact with the CO₂ present in the air. In FIG. 2, air 8 is blown to expedite the pace of the carbonation reaction. The beads are arranged in a stack on an openwork structure. Beads coated with fresh sorbents 31 are continuously introduced at the top of the bead stack, while beads with a carbonated coating 32 are continuously discharged from the bottom of the bead stack. Once the beads are extracted from the contactor 10, they are fed into a separation device such a rotating trommel 50, where the carbonated outer layer is peeled off. The bead cores 30 are then routed to the milk of lime bath 40 to repeat the process. The carbonated materials are collected from the rotating trommel 50 and transferred to a kiln so that the sorbent can be regenerated.

Furthermore, a flowable or malleable composition can be a precursor for a sorbent shaped body. One or more of these sorbent shaped bodies can be used for CO₂ capture in air. To this end, the shaped bodies are placed in or on a stationary or moving support or containment device selected from a non-exhaustive group comprising: trommel, plate, bucket, pile, tray, filter media, cartridge, grate, tile, wall, brick, carbonated product, net, ground and gabion. Preferably, shaped bodies have a water content of at least 5%, preferably at least 10%, and/or at most 20%, preferably at most 15% by weight of said bodies. A drying step may be required for the shaped bodies obtained from a malleable or flowable composition to reach the above-mentioned water content range.

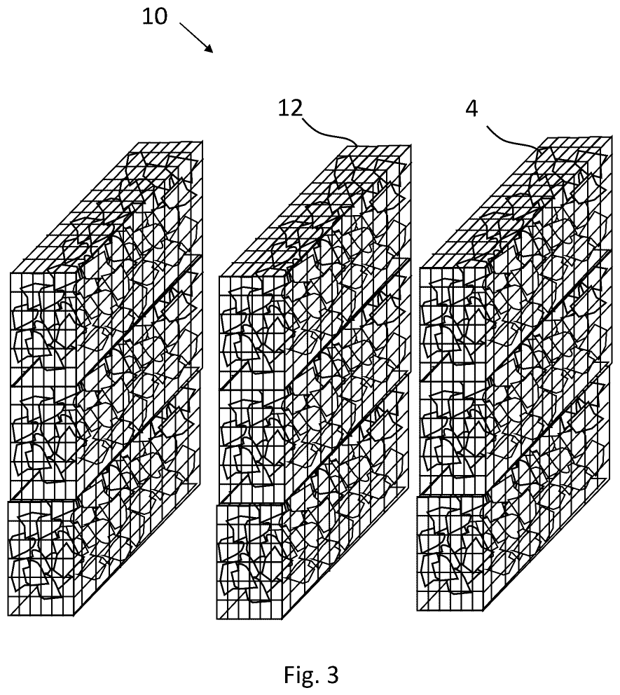

FIG. 3 shows a contactor 10 in the form of gabions 12, according to a further embodiment of the present disclosure. The gabions 12 contain shaped bodied 4 obtained with the above mentioned flowable or malleable composition according to the present disclosure. The gabions 12 can be stacked on the ground outside or inside. This direct air approach requires a minimum management as the gabions 12 can be left unattended and then collected once sufficiently carbonated. Alternatively, the shaped bodied 4 can be formed with a powder composition according to the present disclosure.

Moreover, a calcium hydroxide-based powder composition can be placed in or on a stationary or moving support selected from the non-exhaustive group comprising: trommel, plate, bucket, pile, tray, filter media, such as clothes or bags in a bag filter, cartridge, grate, tile, wall, brick, carbonated product ground and net. Preferably, the hydroxide-based powder composition supplied to the support has a water content of at least 5% by weight, preferably at least 10% by weight, and/or at most 20% by weight, preferably at most 15% by weight of said composition. The water content could be lower than 5%. While a reduction of the water content below the threshold of 5% should not be excluded, a minimum water content is advantageous as water facilitates the kinetics of the carbonation process at low temperatures (e.g., 2° C. to 50° C.), which is primarily governed by ionic reactions.

The calcium hydroxide-based powder composition in the form of powders can also serve as a sorbent in a packed bed (e.g., fixed bed or moving bed) or fluidized bed such as a bubbling bed, a spouted bed, a circulating fluidized bed or an entrained bed. Alternatively, small sorbent shaped bodies with dimension lower than 10 mm can also be used in a packed bed or fluidized bed.

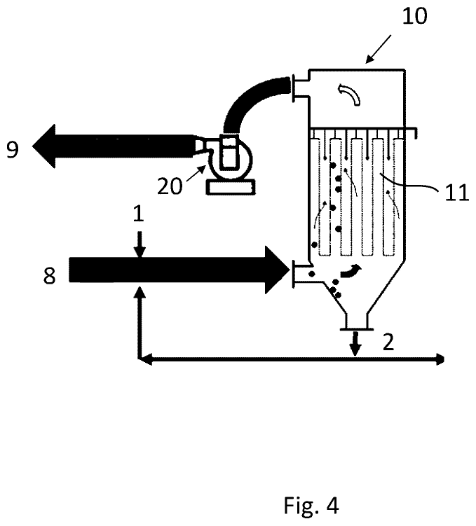

A powder-based sorbent composition can also be used for capturing CO₂ in air in combination with a filtering media such as clothes or bags in a bag filter. For instance, FIG. 4 shows a direct air capture process using a filter media 11 to filter the sorbent according to an embodiment of the present disclosure. Fine calcium hydroxide-based particles 1 are introduced into an air flow 8. These particles 1 are carried along by the air flow 8 to the contactor 10 containing the filtering media 11, where they are maintained in contact with the air flow 8, ensuring the capture of CO₂. The depleted air flow 9 is removed from the contactor using a fan. The filtering media 11, particularly the bag filters are periodically cleaned by reversing the air flow or by injecting a pulse of compressed air on the clean side of the bags to discharge the sorbent 2 from the bag filters for collection. The collected sorbent can then undergo a decarbonation process, such as in a kiln (not shown). Optionally, a fraction of the collected sorbent 2 can be recycled to the air flow 8 as illustrated in FIG. 4. Optionally, the collected sorbent 2 can be separated according to conversion level, the leaner sorbent being recycled and sorbent richer in carbonate being separated for further processing (decarbonation).

A calcium hydroxide-based composition in the form of a malleable or flowable composition, shaped bodies or powders, according the present disclosure can be directly exposed to ambient air or to a conditioned air.

One or more of the following parameters of the conditioned air can be adjusted in order to enhance the degree of conversion and, optionally the kinetics thereof: an air flow rate/speed, an air temperature, an air relative humidity, and an air absolute humidity.

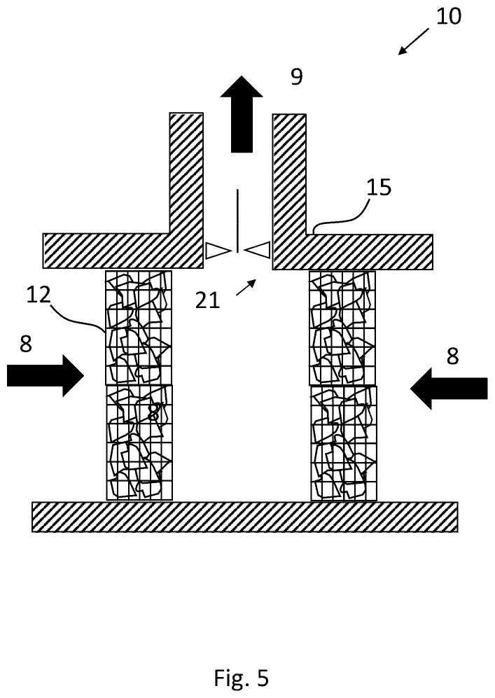

The embodiment of FIG. 5 differs from that of FIG. 3, in that the gabions 12 are integrated into a structure that enables control of the carbonatation process. This structure includes a covering element 15 on top of the gabions. A fan is positioned within the covering element 15. The fan 21 is operated to continuously draw air 8 through the opposed stacks formed by the gabions 12. This configuration establishes a flow path with inlets on the outer sides of the stacks and an outlet positioned downstream from the fan 21. Optionally, the air flow drawn 8 is adjusted by adjusting the speed of the fan 21 depending on the CO₂ concentration in vented air 9. For instance, the fan rotational speed (via variable speed drive) is controlled by measuring the CO₂ concentration at the contactor outlet.

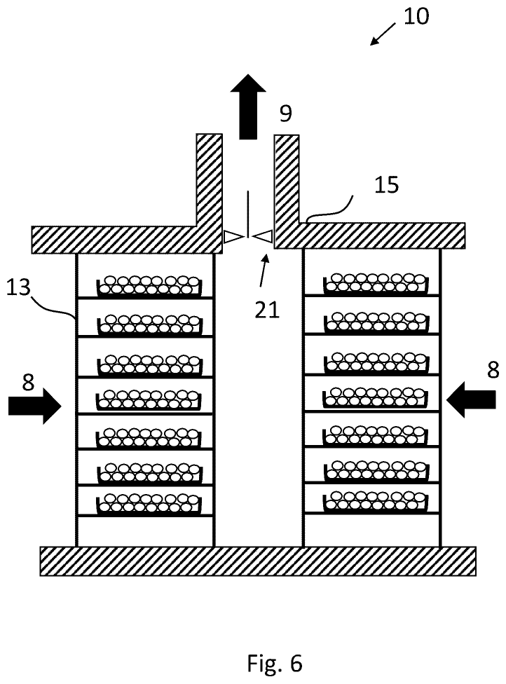

FIG. 6 depicts an alternative embodiment to the gabions shown in FIG. 5, where baskets 13 containing the shaped bodies 4 of calcium hydroxide-based composition according to the present disclosure are arranged on shelves 12. In an alternative embodiment, the shaped bodies can be replaced by powder, milk of lime or lime putty.

Similarly, the characteristics of the sorbent can be adjusted in order to optimize the conversion by modifying at least one of following: the flow rate a calcium hydroxide-based composition, the residence time of the calcium hydroxide-based composition, the inventory of a calcium hydroxide-based composition and/or an absolute water content inside the calcium hydroxide-based composition.

Theses parameters (air characteristics and/or sorbent characteristics) can be adjusted by one of the following control means, such as valves, guiding blade, fans, blowers, humidifiers, coolers, and/or heaters. Equally, means for forming ridges on the surface of the powder composition or for stirring the composition (e.g. with beater) can be employed to homogenize said calcium hydroxide, thereby preventing stratification.

Preferably, the calcium hydroxide-based sorbent composition can be placed in an air flow channel that comprises an air flow inlet and an air flow outlet. In this setup, one or more of the aforementioned conditioned air characteristics are adjusted based on element such as weather conditions, particularly an ambient air temperature and/or an air relative humidity as measured or estimated at the air flow inlet. The carbonation process can be monitored by considering the carbonate content in said composition at one or more locations and/or the difference in CO₂ concentration between the air flow inlet and flow outlet, in particular the air flow should be adapted according to capture rate at a given time. A parameter that commonly affects carbonation is humidity level, and as such, the humidity of the air in contact with the sorbent composition. This parameter can be controlled to maintain a high level of humidity. Alternatively or additionally, the sorbent can be humidified in a controlled manner to regulate its moister content.

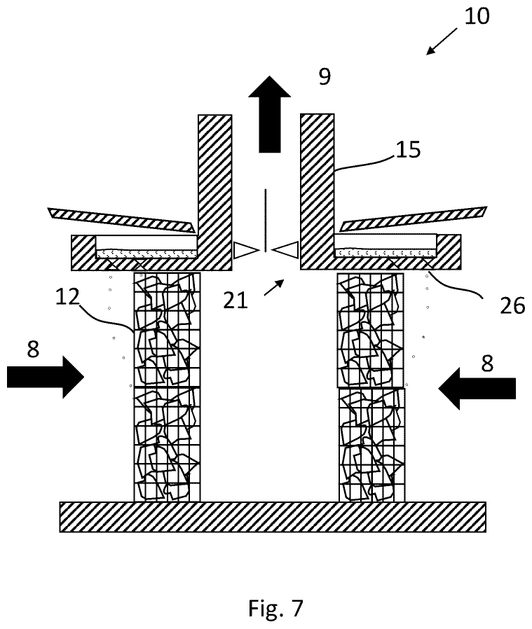

The embodiment according to FIG. 7 differs from that of FIG. 5 in that it includes humidifying means with a water collector to maintain the relative humidity is maintained above a certain threshold to promote carbonation. Typically, one or more humidity sensors (not shown) can be placed on the outer sides of the gabions 12. Based on the humidity measurement, the draining valves 26 of the humidifying means positioned above the gabions 12 are opened or closed to regulate the water supply. One or more CO₂ sensors (not shown) can be disposed upstream and downstream of the gabions 12 to monitor the CO₂ in the air; and then indirectly determine the capture rate in the gabions 12 and then determine the timing for collecting the carbonated materials. A heating system (not illustrated) can be also provided in order to operate at low temperature and prevent freezing. The energy for driving the fan 21, the controller and valves 26, and optionally the heater can be provided by power source such as a solar panel mounted on the covering element.

The calcium hydroxide-based sorbent composition is intended to be exposed to temperature falling in the range of 2° C. to 50° C., preferably within the range 15° C. to 50° C. and/or relative humidity levels falling within the range of 10% to 95%, preferably 70 to 100%. To achieve this, the contactor(s) can be strategically located in areas with suitable weather conditions that provide optimal carbonatation. If the desired weathers conditions cannot be guaranteed in the available locations, air conditioning can be implemented to compensate for climatic variations and maintain the humidity and temperature within appropriate ranges, in particular with high relative humidity (70% to 100%) and/or low temperatures (5° to 15° C.). In cases where the DAC locations (usually driven by sequestration capacities) are unsuitable due to climate constraints, limited access to energy sources, the calcium hydroxide-based composition according to the present disclosure demonstrates surprising adaptability for CO₂ capture in air with low relative humidity and high temperature, making it efficient even in arid climates.

It should be emphasized that the calcium hydroxide-based composition according to the present disclosure also performs well for carbonation in a rich CO₂ atmosphere such as flue gas. The carbonation reaction is typically effective at high temperatures, ranging from 450° C. up to 600° C. This type of carbonation is commonly referred to as high-temperature carbonation, in contrast to the low/ambient temperature (e.g. 2° C. to 50° C.) carbonation encountered in CO₂ capture from air (also known as Direct Air Capture). The composition can also be used for example for flue gases at temperature higher than ambient but still moderate, for example above 100 or 120° C. Furthermore, when appropriate in the context, the term “air” used herein can be replaced by “CO₂ containing gas”, for example flue gas.

After exposure to air, the carbonate sorbent generally takes the form of powders, agglomerated powders, coated layers, or shaped bodies. Depending on the carbonation conditions, the carbonated sorbent particles may become worn or fused together. It is advantageous to collect the carbonated sorbent once the molar conversion of Ca(OH)₂ into CaCO₃ reaches a predefined level. The level of conversion can be determined by the CO₂ content present in the carbonated composition. To evaluate the conversion level, a sample of the carbonated sorbent can be taken and analyzed in a lab. Alternatively, in-situ monitoring can be implemented using an analyzer to measure the chemical composition of the sorbent directly in or on the contactor in real time or at regular intervals. Additionally, a model-based predictive algorithm can be used to estimate the conversion level based on recorded atmospheric data. Achieving a high level of conversion reduces the energy needed for decarbonation, as any unreacted calcium hydroxide would be unnecessarily heated and de-hydrated in a calciner.

The collected calcium carbonate can be effectively conditioned to increase its calcium carbonate content before undergoing decarbonation to address the aforementioned limitations.

Such conditioning includes at least one of drying, grinding, milling, classifying, dehydroxylating, or purifying the collected calcium carbonate-based composition, or any combination thereof. Specifically, the purification step involves separating some of the unreacted calcium hydroxide from the collected calcium carbonate-based composition. This can be achieved through purification processes such as air classification, leaching, peeling, flotation, or any combination thereof.

Then, the raw, conditioned, or purified carbonate sorbent is decarbonated to be either recycled for further direct capture applications or for another purpose. During the decarbonation process, CO₂ is extracted from the collected calcium carbonate-based composition through direct or indirect calcination, electrochemistry, or chemical attack. In indirect calcination (in which combustion is done in a separate chamber and heat passes through a wall to reach the material to be treated), heat can be supplied by the combustion of carbon-neutral fuels, hydrogen combustion, or electric heaters. In direct calcination, heat can be generated by air-based combustion of carbonous fuel/H₂. The exhaust gas generated during the process can be treated in a post-combustion CO₂ capture system, such as amine gas treating or pressure swing absorption. Oxyfuel firing (using carbonous fuel and/or H₂), can also be considered. Alternatively, electrical heat input methods such as plasma or induction can be used. Electrochemistry involves performing electro-dissolution, while in a chemical attack, the carbonated material can react with a strong base such as NaOH or a strong acid such as HCl.

The heat released during the slaking process or the sensible thermal energy in the decarbonated materials can be advantageously recovered in several applications such as for preheating the carbonated materials or for drying the slaked lime. Therefore, it is advantageous to have the hydration unit and the decarbonation unit located in the same facility. This measure would also reduce the transportation and stock duration.

To illustrate the present disclosure, various calcium hydroxide powder compositions were prepared.

As raw materials, an industrial soft burnt quicklime with the following characteristics was used:

TABLE 1

| | | | CO₂ as | |
|---|---|---|---|---|
| Reactivity | PSD | Chemistry | carbonate | CaO |
| (t60) | (sieving) | (ICP) | (% CO₂) | available |
| 33 s | D99 = 6.3 mm | MgO: 0.48 wt % | 2.3 wt % | 94% |
| | D50 = 1.9 mm | SiO₂: 0.28 wt % | | |
| | D25 = 0.5 mm | Al₂O₃: 0.1 wt % | | |
| | | Fe₂O₃: 0.07 wt % | | |

The reactivity of quicklime was evaluated using t60 parameter which corresponds to the time needed to raise the temperature of the lime/slaking water system up to 60° C., slaking of the lime being conducted following the protocol described in the standard EN 459-2 § 7.6 (July 2021 version).

The particle size distribution was determined using dry sieving method which consist in dividing the initial material by means of a series of sieves with different aperture sizes and by weighting the fraction of initial material retained on the various sieves.

Chemical composition was measured using ICP-OES (inductively coupled plasma-optical emission spectroscopy).

The CO₂ contained in the lime in the form of carbonate was measured according to EN 459-2 § 6.6 (July 2021 version) which consist in releasing gaseous CO₂ though a reaction with hydrochloric acid and determined volumetrically.

Different hydrated lime samples were produced by mixing one kilogram of quicklime with a water/lime weight ratio between 0.6 and 1.05 in a laboratory mixer. In some cases, delaying additives (Diethylene Glycol—DEG or Triethanolamine—TEA) were also added.

After completion of the hydration reaction, the residual humidity (free moisture) was determined by measuring the mass loss following heating the samples at 150° C. for 2 hours in a drying oven (EN 459-2 § 6.5 Jul. 2021 version)

The dried product was ground in order to break calcium hydroxide agglomerates and reduce particle size to below 250 μm.

The hydrates obtained were characterized as follows. The BET specific surface area of the powders was measured in accordance with standard IS09277, second Edition of Sep. 1, 2010. The pore volume and pore distribution as a function of pore diameter were calculated based on the step-by-step analysis of the isotherm desorption branch using the BJH method of Barrett, Joyner and Halenda (1951), conventionally used with 77K nitrogen as adsorbent gas. The method is described in standard DIN66134 (February 1998 version). It allows the calculation of pore volume distribution as a function of pore diameter on the assumption that the pores are cylindrical. The pore volume and pore volume distribution were determined for the range of pores having a diameter ranging from 20 to 1000 Å. The results are given below per interval of 100 Å (20-100 Å, 100-200 Å, etc.). On the basis of pore volume distribution determined with the BJH method, the BJH pores size distribution of the pores was also calculated per interval of 100 Å again assuming the pores are cylindrical.

### Example

Eleven compositions were tested having the following characteristics:

TABLE 2

| | | | Residual |
|---|---|---|---|
| Sample No | H₂O:CaO | Additives:CaO | moisture |
| 1 | 0.6 | 0.0% | 0.53 |
| 2 | 0.8 | 0.0% | 9.74 |
| 3 | 0.9 | 0.0% | 15.91 |
| 4 | 0.98 | 0.0% | 20.29 |
| 5 | 1.05 | 0.0% | 24.29 |
| 6 | 1.05 | 0.3% DEG | 24.31 |
| 7 | 1.05 | 0.6% DEG | 24.61 |
| 8 | 1.05 | 1.0% DEG | 23.78 |
| 9 | 1.05 | 1.4% DEG | 23.24 |
| 10 | 0.8 | 1.0% DEG | 11.61 |
| 11 | 0.8 | 1.5% | 10.33 |
| | | TEA/ATEA | |

TABLE 3

| | | Porous | Porous | Porous | Porous |
|---|---|---|---|---|---|
| | | volume in | volume in | volume in | volume in |
| | BET specific | the range | the range | the range | the range |
| Sample | surface area | 20-1000 Å | 20-100 Å | 20-200 Å | 200-1000 Å |
| No | (m²/g) | (cm³/g) | (cm³/g) | (cm³/g) | (cm³/g) |
| 1 | 18.7 | 0.09 | 0.02 | 0.04 | 0.05 |
| 2 | 23.9 | 0.12 | 0.03 | 0.06 | 0.06 |
| 3 | 23.5 | 0.13 | 0.02 | 0.05 | 0.08 |
| 4 | 23.8 | 0.14 | 0.02 | 0.05 | 0.09 |
| 5 | 22.9 | 0.14 | 0.01 | 0.04 | 0.10 |
| 6 | 37.8 | 0.19 | 0.03 | 0.09 | 0.10 |
| 7 | 38.4 | 0.20 | 0.04 | 0.10 | 0.10 |
| 8 | 46.1 | 0.20 | 0.05 | 0.11 | 0.09 |
| 9 | 48.0 | 0.19 | 0.05 | 0.11 | 0.08 |
| 10 | 44.0 | 0.15 | 0.05 | 0.09 | 0.06 |
| 11 | 50.6 | 0.13 | 0.06 | 0.08 | 0.05 |

Samples N° 1 to 5 illustrate the influence of the water-to-lime ratio (and in fine the residual moisture) when no additives are used.

Samples N° 6 to 9 highlight the influence of DEG additive level, with the objectives of assessing the effect of varying BET specific surface area for compositions with a relatively high porous volume in both the 20-200 Å and 200-1000 Å ranges.

Samples N° 10 to 11 illustrate the influence of additive types such as DEG and TEA for an intermediate water-to-lime ratio, with the objectives of producing compositions with high BET specific surface area but a lower porous volume, especially in the range 200-1000 Å

The CO₂ capture performances of the different samples were studied by placing a 3 mm layer of hydrated material powder in a set of 150 mm×150 mm×3 mm plastic mold placed in a weathering chamber (Weiss Technik CareEvent C/1400/5/30 CO₂).

The weathering chamber is equipped with systems to monitor and regulate temperature, relative humidity and CO₂ concentration and two axial fans in order to ensure internal air circulation. The fans have a nominal rotational speed of 1200 rpm and a diameter of 20 cm. The target temperatures and the target relative humidity were selected to represent typical weather conditions. The CO₂ concentration was multiplied by around five times the reference natural CO₂ concentration (400 ppmv) to accelerate the carbonation process at ambient temperature. It is assumed that the results obtained with an enriched CO₂ atmosphere can be extrapolated to atmospheric conditions, considering the low concentration level and narrow range investigated. The temperature, the relative humidity and CO₂ concentration are regulated to remain within the accuracy ranges presented in the table below:

TABLE 4

| | |
|---|---|
| Range | Accuracy |

| | | | | |
|---|---|---|---|---|
| Temperature | 5-50° | C. | +/−0.5-0.7° | C. |
| Relative humidity | 5-90% | RH | +/−3-5% | RH |

| | | | |
|---|---|---|---|
| CO₂ concentration | 400-2000 | ppmv | +/−10% |

Hydrated lime samples were tested in the following conditions:

TABLE 5

| | | Relative | CO₂ | Test |
|---|---|---|---|---|
| | Temperature | humidity | concentration | duration |
| Test A | 10° C. | 75% | 2000 ppm | 48 hrs |
| Test B | 30° C. | 75% | 2000 ppm | 48 hrs |
| Test C | 30° C. | 60% | 2000 ppm | 72 hrs |
| Test D | 30° C. | 45% | 2000 ppm | 175 hrs |

At the end of the experiments, the CO₂ content was measured according to EN 459-2 § 6.6 mentioned above.

TABLE 6

| | | Additives: | | Test A | Test B | Test C | Test D |
|---|---|---|---|---|---|---|---|
| Sample | H2O:CaO | CaO | | (wt % | (wt % | (wt % | (wt % |
| No | (wt/wt) | (wt/wt) | | CO₂) | CO₂) | CO₂) | CO₂) |
| 1 | 0.6 | 0 | | 40.1 | 32.0 | 22.7 | 26.4 |
| 2 | 0.8 | 0 | | 39.0 | 33.6 | 22.7 | |
| 3 | 0.9 | 0 | | 40.7 | 32.3 | 23.3 | 25.8 |
| 4 | 0.98 | 0 | | 40.8 | 32.9 | 24.3 | |
| 5 | 1.05 | 0 | | 42.1 | 35.4 | 25.9 | 28.5 |
| 6 | 1.05 | 0.3% | DEG | 42.9 | 41.2 | 34.8 | |
| 7 | 1.05 | 0.6% | DEG | 42.4 | 41.0 | 37.1 | 35.3 |
| 8 | 1.05 | 1% | DEG | 43.0 | 42.0 | 38.6 | 36.9 |
| 9 | 1.05 | 1.4% | DEG | 41.2 | 43.8 | 39.3 | |
| 10 | 0.8 | 1% | DEG | 38.1 | 41.3 | 40.0 | 31.6 |
| 11 | 0.8 | 1.5% | TEA | 26 | 39.9 | 25 | 15.3 |

It represents the amount of CO₂ chemically bound to the solid at the end of the experiment and is therefore proportional to the conversion of the calcium hydroxide into carbonate.

The CaCO₃ content (wt %) can be determined from the CO₂ content (wt %) with the following formula (1) based on the atomic masses:

$${CaCO}_{3} ( wt \% ) = 100 / 44 \cdot {CO}_{2} ( wt \% )$$

The molar conversion of Ca(OH)₂ into CaCO₃ is calculated with the following formula (2):

$$X ( Molar conversion of {Ca ( OH )}_{2} into {CaCO}_{3} ) = \frac{( \frac{{CaCO}_{3} ( wt \% )}{100} )}{( \frac{{CaCO}_{3} ( wt \% )}{100} ) + ( \frac{100 \% - {CaCO}_{3} ( wt \% )}{74} )}$$

where it is assumed that the composition consists in two compounds CaCO₃ and Ca(OH)₂. The Ca(OH)₂ content is directly derivable from the CaCO₃ content, as follows Ca(OH)₂(wt %)=100%−CaCO₃ (wt %). TABLE 7 below shows the correspondence between the CO₂ content and the CaCO₃ content or the molar conversion of Ca(OH)₂ into CaCO₃ (also known as molar conversion of calcium hydroxide).

TABLE 7

| | | molar |
|---|---|---|
| | | conversion of |
| CO₂ (%) by | CaCO₃ (%) by | Ca(OH)₂ into |
| weight | weight | CaCO₃ |
| 0% | 0.00% | 0% |
| 2% | 4.55% | 3% |
| 4% | 9.09% | 7% |
| 6% | 13.64% | 10% |
| 8% | 18.18% | 14% |
| 10% | 22.73% | 18% |
| 12% | 27.27% | 22% |
| 14% | 31.82% | 26% |
| 16% | 36.36% | 30% |
| 18% | 40.91% | 34% |
| 20% | 45.45% | 38% |
| 22% | 50.00% | 43% |
| 24% | 54.55% | 47% |
| 26% | 59.09% | 52% |
| 28% | 63.64% | 56% |
| 30% | 68.18% | 61% |
| 32% | 72.73% | 66% |
| 34% | 77.27% | 72% |
| 36% | 81.82% | 77% |
| 38% | 86.36% | 82% |
| 40% | 90.91% | 88% |
| 42% | 95.45% | 94% |
| 44% | 100.00% | 100% |

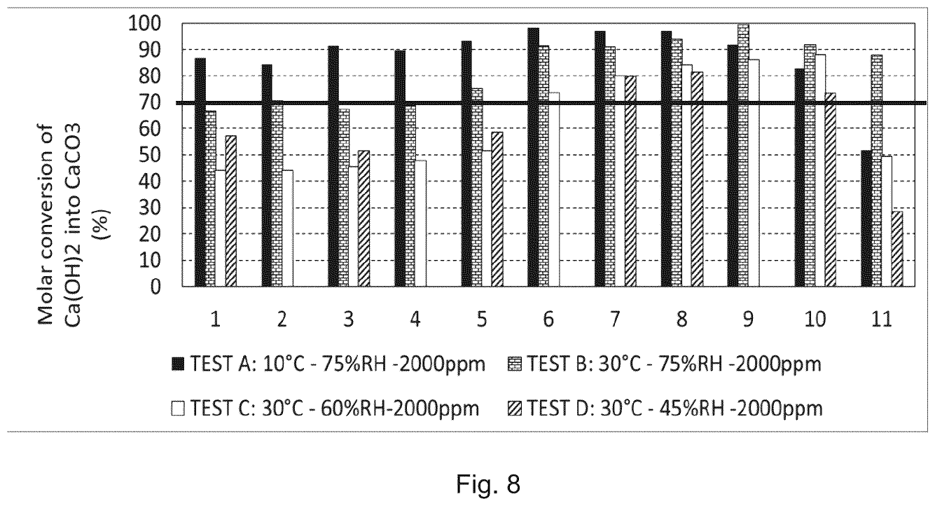

The results of the carbonation experiments are presented in FIGS. 8 to 15 and discussed in the subsequent paragraphs.

FIG. 8 discloses a comparison of molar conversions of calcium hydroxide compositions (samples) tested under four different simulated climatic conditions, namely Test A (CO₂: 2000 ppmv, 10° C. and 75% RH), Test B (CO₂: 2000 ppmv, 30° C. and 75% RH), Test C (CO₂: 2000 ppmv, 30° C. and 60% RH) and Test D (CO₂: 2000 ppmv, 30° C. and 45% RH). The molar conversions of Ca(OH)₂ into CaCO₃ are based on the CO₂ contents from TABLE 6 that are recalculated using formulas (1) and (2). TABLE 7 indicates the correspondence between the molar conversions of Ca(OH)₂ into CaCO₃ and the CO₂(%) content for reference values (e.g., 0%, 2%, 4% . . . , 44%).

Samples 6 to 10 represent the present disclosure. Samples 1 to 5 and 11 are comparative examples. Samples 6 to 10 exhibit a molar conversion (of Ca(OH)₂ into CaCO₃) above about 70 mol % in the four tests A, B, C, D (when performed). This indicates that the hydroxide composition of the samples 6 to 10 is more robust in terms of molar conversion compared to the other hydrated lime samples when subjected to different weather conditions. To achieve such a molar conversion of at least 70% corresponding to a CO₂ content of 33%, the composition has a partial pore volume equal to or higher than 0.09 cm³/g, in particular higher than 0.1 cm³/g, said partial pore volume being calculated according to the BJH method for a range of pores having a diameter between 20 and 200 Å in accordance with standard DIN 66134 (February 1998 version). Preferably, the difference between a total pore volume being calculated according to the BJH method for a range of pores having a diameter of between 20 and 1000 Å in accordance with standard DIN 66134 (February 1998 version) and said partial pore volume is equal to or higher than 0.06 cm³/g, preferably higher than 0.08 cm³/g. This element relates to a second aspect of the present disclosure also covered by the samples 6 to 10.

FIG. 8 shows that a high BET specific surface area does not necessarily lead to a high molar conversion. Indeed, sample 11, despite a BET specific surface area >40 m²/g, does not achieve higher conversions than the sample 1 to 5 having low BET specific surface areas around 20 m²/g.

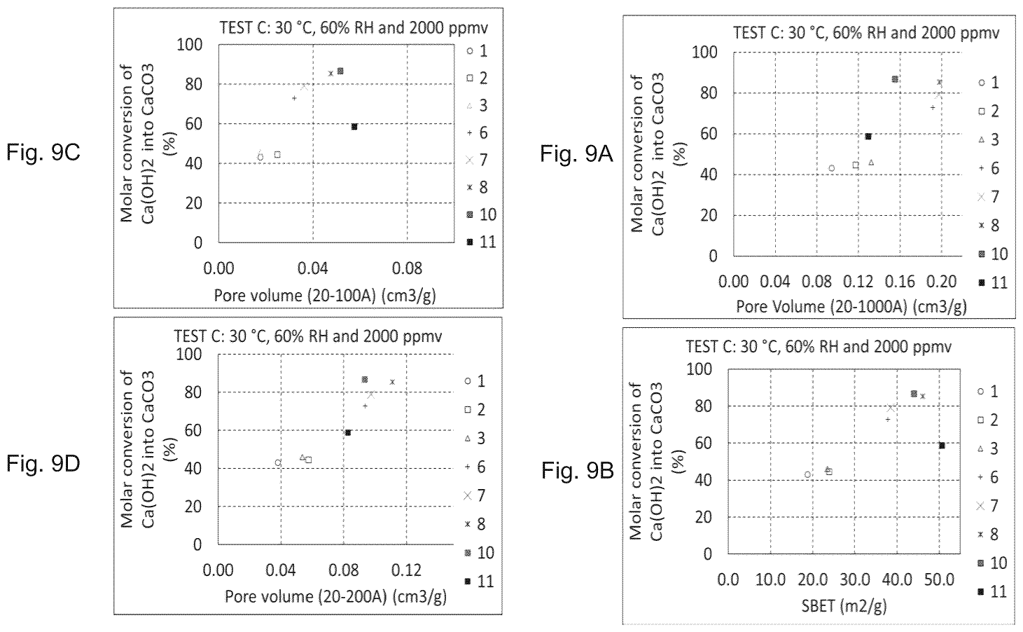

FIGS. 9A, 9B, 9C and 9D disclose a comparison of molar conversions of the calcium hydroxide compositions (samples) under Test C (30° C. and 60% RH) as a function of the microstructure characteristics (BET specific surface area, BJH 20-1000 Å, BJH 20-100 Å, BJH 20-100 Å). FIGS. 9A, 9B, 9C and 9D illustrate that there is a correlation between the molar conversion under Test C and the parameters of the hydrated limes such as porous volume 20-1000 Å, 20-100 Å, 20-200 Å or the BET specific surface area. In FIG. 9D, the narrow width cluster in the graph corresponding the porous volume in the range 20-200 Å highlights that there is a strong correlation between the molar conversion and the porous volume in the ranges 20-200 Å. This finding indicates that the pore volume in the ranges 20-200 Å is a key parameter to achieve a high molar conversion in dry condition.

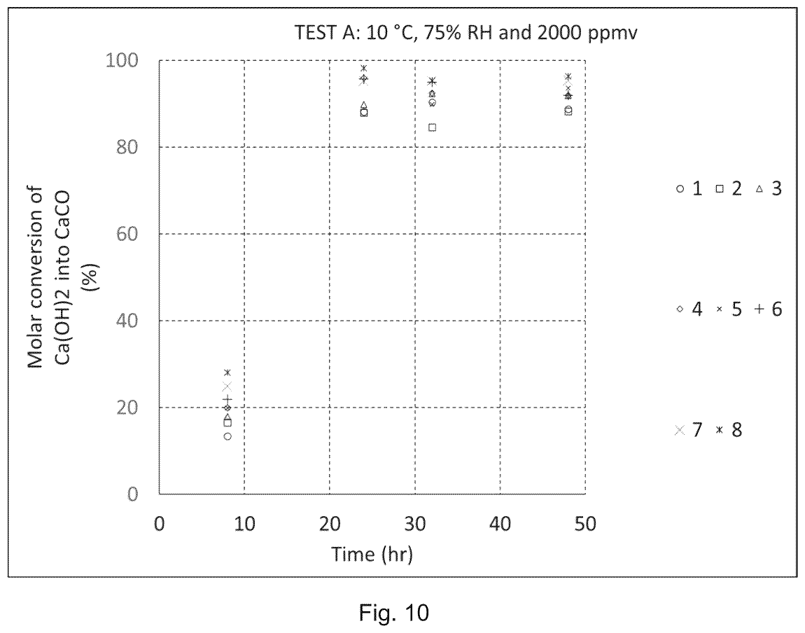

FIG. 10 shows molar conversion evolution over time of the calcium hydroxide compositions (samples) under Test A (CO₂: 2000 ppmv, 10° C. and 75% RH). The samples plotted reach a plateau within 30 hours. The conditions under Test A correspond to a tempered climate in the autumn, winter or spring seasons characterized by a high humidity level and low temperatures.

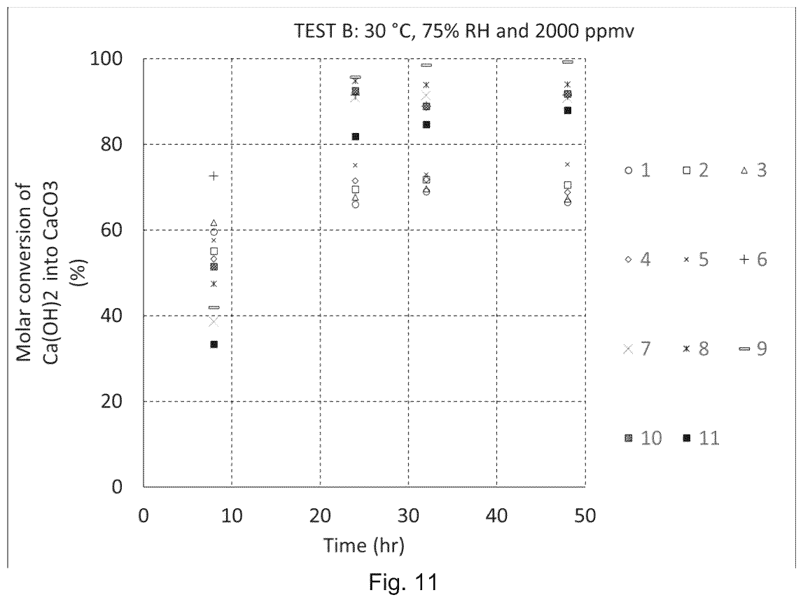

FIG. 11 shows molar conversion evolution over time of the calcium hydroxide compositions (samples) under Test B (CO₂: 2000 ppmv, 30° C. and 75% RH). Test B differs from Test A in that the temperature is increased from 10° C.° to 30°. Test B relates to tropical climatic conditions or conditions encountered in the summer in tempered climate. The spread between the highest molar conversion and the lowest is around 40%, doubling the spread of Test A.

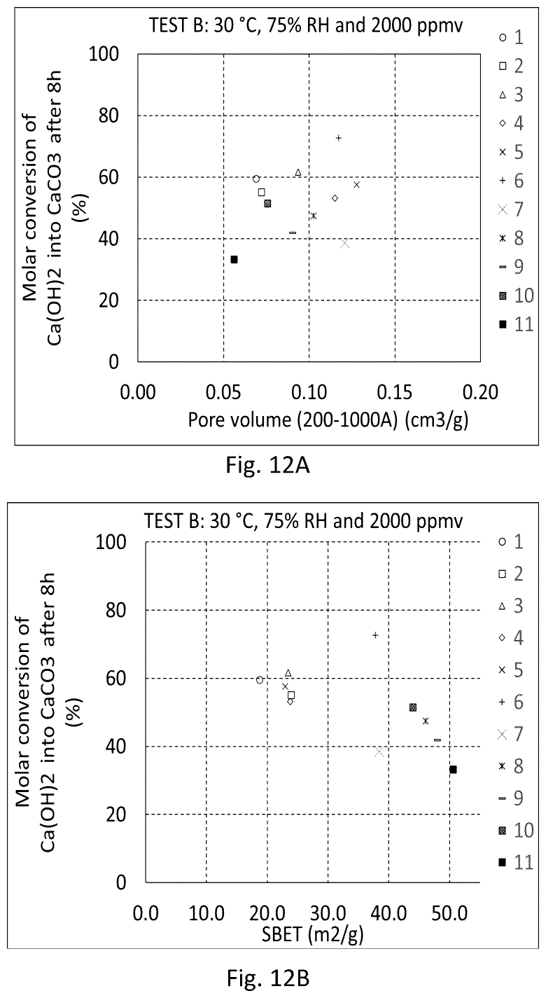

FIGS. 12A and 12B show two graphs illustrating the influence of the BET specific surface area and the porous volume in the range 200-1000 A on the carbonation kinetics. For this purpose, the molar conversion after 8 hours under Test B (CO₂: 2000 ppmv, 30° C. and 75% RH) is used to define the carbonation kinetics. FIG. 12B shows that the kinetic is negatively correlated with BET specific surface area. FIG. 12A shows that the kinetics is correlated with larger pores, namely between 200-1000 Å. The large pores are important as they promote the diffusion of the CO₂ into the small pores. For this reason, the calcium hydroxide composition according to the present disclosure needs to have not only sufficient small pores in the range 20-200 A to ensure a high asymptotic conversion but also a sufficient large porous volume in the range 200-1000 A to ensure a rapid molar conversion.

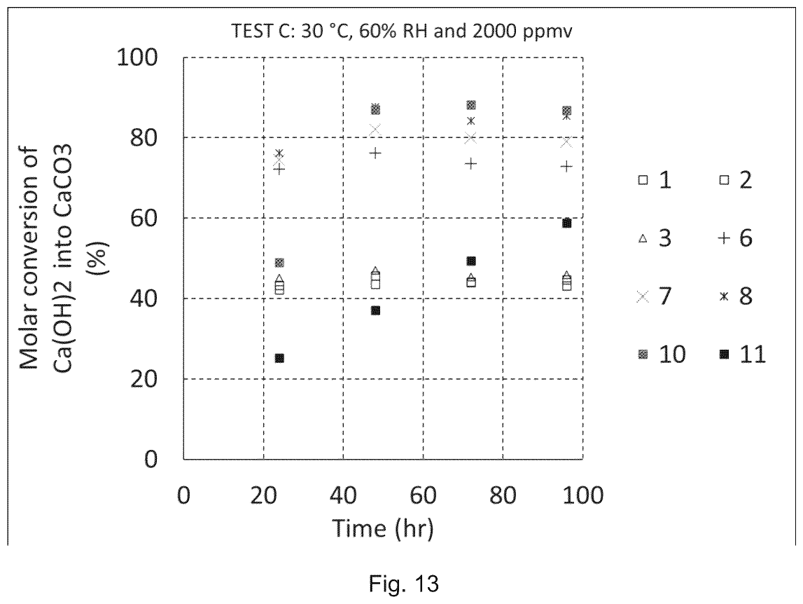

FIG. 13 shows molar conversion evolution over time of the calcium hydroxide compositions (samples) under Test C (CO₂: 2000 ppmv, 30° C. and 60% RH). Test C differs from Test B in that the relative humidity is decreased from 75% to 60%. Test C relates continental or Mediterranean climates. The spread between the highest molar conversion and the lowest is around 50%, around 10% more than for Test B. The maximal molar ratio is around 85%. There is a drop of 10% compared to Test B. As discussed in the previous paragraph, the right balance between the porous volume in the range 20-200 Å and the porous volume in the range 200-1000 Å promotes the kinetics as discussed for FIGS. 12A and 12B.

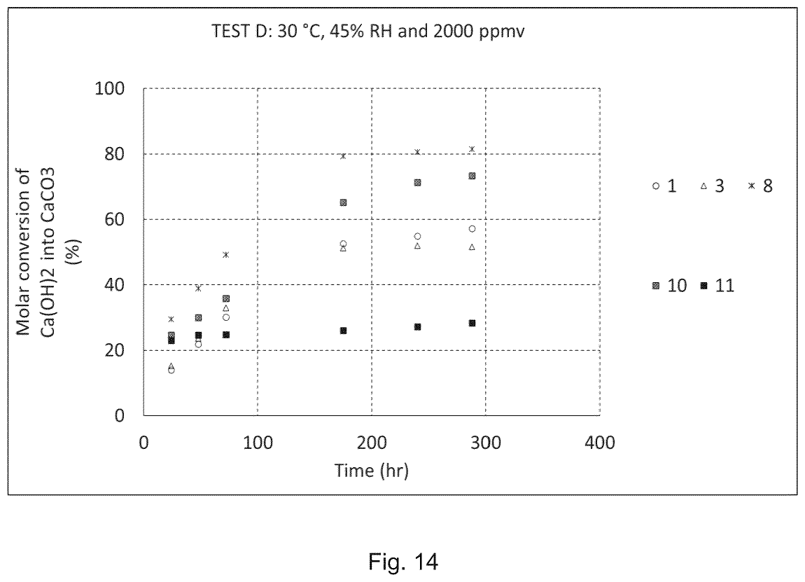

FIG. 14 shows molar conversion evolution over time of the calcium hydroxide compositions (samples) under Test D (CO₂: 2000 ppmv, 30° C. and 45% RH). Test D differs from Test C in that the relative humidity is decreased from 60% to 45%. Test C relates climatic arid conditions. Compared to Test C, the spread between the highest molar conversion and the lowest amounts to around 55%. This spread is slightly larger than that for Test C. The maximal molar ratio is around 80%. There is a drop of 5% compared to Test C. As discussed in the previous paragraph, the right balance between the porous volume in the range 20-200 Å and the porous volume in the range 200-1000 Å promotes the kinetics as discussed for FIGS. 12A and 12B or 13. FIG. 14 shows that traditional hydrated limes with a lower BET specific surface area (samples 1, 3, 5) perform even better than an hydrated lime with higher BET specific surface area and low porous volume in the range 200-1000 Å (sample11), under the dry conditions of Test D. The reason for this counterintuitive result is that this hydrated lime with a high BET specific surface area and low porous volume in the range 200-1000 Å does not have enough large pores in the range 200-1000 Å to ensure diffusion to the small pores.

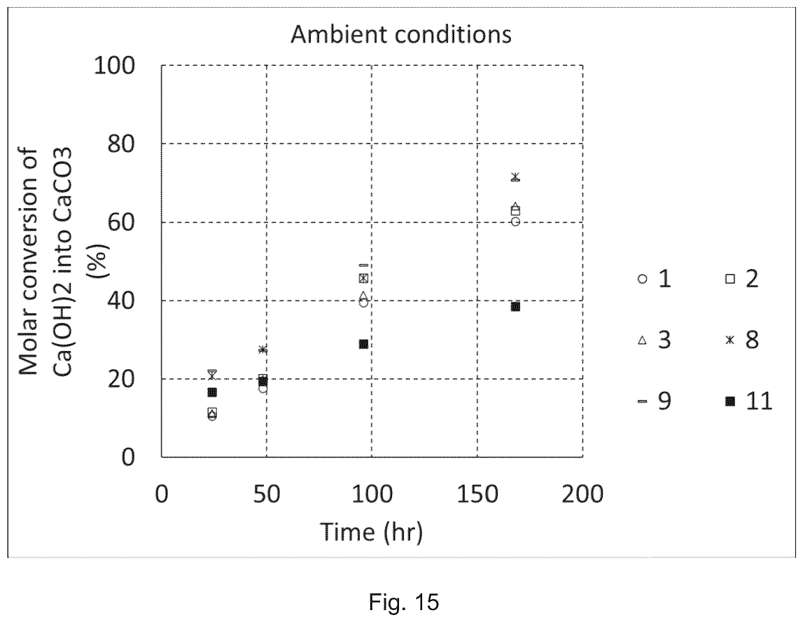

FIG. 15 shows molar conversion evolution over time of calcium hydroxide compositions (samples) under ambient condition (average CO₂ concentration ˜455 ppmv, temperature: 10.5° C., relative humidity: 63%). It is observed that the maximal molar conversion (plateau) is still not reached after 160 hours and a molar conversion spread is present. In particular, sample 11 has achieved a low conversion at the end of the test.

By BJH 20-100, BJH 20-200, BJH 20-1000 is meant the pore volume being calculated according to the BJH method for a range of pores having a diameter of between 20 and 100 Å, 20 and 200 Å and 20 and 1000 Å respectively in accordance with standard DIN 66134 (February 1998 version)

Additional aspects and features of the disclosure are presented below, without limitation, as a series of enumerated clauses.

A1. A process for direct capture of carbon dioxide in air comprising the following steps:
optionally providing a calcium hydroxide-based composition;
contacting said composition with air so as to capture CO₂ contained in said air by transforming at least some of the calcium hydroxide of said composition into calcium carbonate, forming a calcium carbonate-based composition;
optionally collecting the calcium carbonate-based composition;
optionally extracting at least some CO₂ from at least some of the collected calcium carbonate-based composition, prefer-ably via calcination and/or electrolysis,
wherein said calcium hydroxide-based composition has:
optionally a partial pore volume higher than 0.08 cm³/g, preferably higher than 0.09 cm³/g, in particular higher than 0.1 cm³/g, said partial pore volume being calculated accord-ing to the BJH method for a range of pores having a diameter between 20 and 200 Å in accordance with standard DIN 66134 (February 1998 version);
optionally a BET specific surface area greater than 30 m²/g, preferably greater than 40 m²/g, and more preferably greater than 45 m²/g measured according to IS09277 standard (September 2010 version;
optionally wherein the difference between a total pore volume being calculated according to the BJH method for a range of pores having a diameter of between 20 and 1000 Å in accordance with standard DIN 66134 (February 1998 version) and said partial pore volume is equal to or higher than 0.06 cm³/g, preferably higher than 0.08 cm³/g.

A2. The process according to Clause A1, further comprising mixing a calcium hydroxide-based powder composition with water and optionally a first additive or slaking quicklime, possibly partly hydrated, optionally in presence of a second additive in order to obtain a composition with a water content above 35% by weight of said composition, and optionally at most 85% by weight of said composition, in particular said composition being a malleable or flowable composition, such as a putty lime or a milk of lime.

A3. The process according to Clause A1 or A2, the step of providing the calcium hydroxide-based composition comprises providing the malleable or flowable composition such as a putty lime or a milk of lime, preferably said composition having a water content above 35% by weight of said composition, and optionally at most 85% by weight of said composition.

A4. The process according to Clause A2 or A3, further comprising shaping the malleable or flowable composition into shaped bodies (4), in particular 3D printings or extrudate, thereby forming the calcium hydroxide-based composition, preferably forming ridges on the shaped bodies, notably curing said shaped bodies with CO₂ preferably said shaped bodies having at least one dimension greater than 3 mm.

A5. The process according to Clause A4, prior to the shaping of the shaped bodies (4), mixing the malleable or flowable composition with at least one element selected from the group comprising structural elements, such as woven or non-woven fibers, at least one additive, water, or any combination thereof, preferably the at least one additive being selected from the group comprising shaping additive, pore-forming agent, compressive strength enhancer such as cementitious material, additives to increase particle size such as gypsum and air entraining agent;

A6. The process according to Clause A1, further comprising shaping a calcium hydroxide-based powder composition into shaped bodies (4), in particular pellets, granules, extrudates, 3D printings or compacts such as tablets or briquettes, thereby forming the calcium hydroxide-based composition, preferably forming ridges on the shaped bodies, notably curing said shaped bodies with CO₂, preferably said shaped bodies having at least one dimension greater than 3 mm.

A7. The process according to Clause A6, further comprising mixing a calcium hydroxide powder with at least one element selected from the group comprising structural elements such as woven or non-woven fibers, at least one additive, water, or any combination thereof, thereby forming the calcium hydroxide-based powder composition, preferably the at least one additive being selected from the group comprising shaping additive, pore-forming agent, com-pressive strength enhancer such as cementitious material, additives to in-crease particle size such as gypsum and air entraining agent.

A8. The process according to any of Clauses A1, A4 to A7, wherein the supply of the calcium hydroxide-based composition comprises the supply of the shaped bodies (4), in particular pellets, granules, extrudates, 3D printings or compacts such as tablets or briquettes, preferably said shaped bodies having at least one dimension greater than 3 mm.

A9. The process according to the Clause A1 wherein the supply of the calcium hydroxide-based composition comprises the supply of a calcium hydroxide-based composition with water lower than or equal to 35% by weight of said composition, preferably at most 20% by weight, more preferably at most 15% by weight of said composition, and/or at least 5% by weight, preferably at least 10% by weight of said composition, preferably said composition being in the form of powder.

A10. The process according to any of the previous Clauses, wherein the collection of the calcium carbonate-based composition takes place when said com-position reaches a CO₂ content of at least 31%, preferably at least 33%, in particular at least 37% by weight on a dry basis.

A11. The process according to any of the preceding Clauses, further comprising a step of providing a support (11, 12, 13, 14, 30) for the calcium hydroxide-based composition, said support being stationary or in motion relative to a reference frame.

A12. The process according to Clause A8 in combination with any of Clauses 10 to 11, wherein the support is selected from the group comprising trommel, plate, such as corrugated plate, bucket, pile, shelf (14), tray, filter media, cartridge, grate, tile, wall, brick, carbonated product, net, ground, basket (14) and gabion (12).

A13. The process according to Clause A9 in combination with any of Clauses A10 to

A11, preferably further comprising applying said composition on a support to form a layer, in particular forming ridges on said layer, preferably the support being selected from the group comprising trommel, plate, such as corrugated plate, bucket, pile, shelf (14) tray, filter media (11), such as clothes or bags in a bag filter, cartridge, grate, tile, wall, brick, carbonated product ground and net.

A14. The process according to Clause A3 in combination with any of Clauses A10 to A11, preferably further comprising applying said composition on a support to form a layer, in particular forming ridges on said layer, preferably the support being selected from the group comprising plate, such as corrugated plate, bucket, pile, shelf (14), tray, filter media, such as clothes or bags in a bag filter, cartridge, grate, tile, wall, brick, bead (30) carbonated product, ground and net.

A15. The process according to any of Clauses A8 to A9 in combination with any of Clauses 10 to 11, further comprising the step of contacting the calcium hydroxide-based composition with air in a packed bed such as a fixed bed or a moving bed or in a fluidized bed such as a bubbling bed, a spouted bed, a circulating fluidized bed or an entrained bed.

A16. The process according to Clause A9 in combination with any of Clauses A10 to A11, further comprising flowing air through a filter media, such as clothes or bags in a bag filter, comprising the calcium hydroxide-based composition.

A17. The process according to any of the preceding Clauses, wherein the step of contacting the calcium hydroxide-based composition with said air further comprises comprising adjusting (20, 21, 26) at least one of:
an air flow rate,
a calcium hydroxide-based composition flow rate,
a calcium hydroxide-based composition residence time,
a calcium hydroxide-based composition inventory,
an air temperature,
an air relative humidity,
an air absolute humidity, and/or
an absolute water content inside the calcium hydroxide-based composition, with at least one control means for controlling the CO₂ capture in air comprising at least one of:
one or more air flow control elements, such as valve, guiding blade, fan or blower,
calcium hydroxide-based composition flow control elements
a humidifier,
cooler, and/or
heater.

A18. The process according to the preceding Clause, wherein further providing an air flow inlet arranged upstream from the calcium hydroxide-based composition and/or an air flow outlet arranged downstream from the calcium hydroxide-based composition.

A19. The process according to any of the Clauses A17 to A18, wherein the step of adjusting comprises adjusting as a function of at least one of:
weather conditions, in particular an ambient air temperature and/or an air relative humidity as measured or estimated at the air flow inlet,
the CO₂ content in said composition at one or more locations, and/or
the difference in CO₂ concentration between the air flow inlet and outlet.

A20. The process according to any of the preceding Clauses, wherein, in the step of contacting said composition with said air, the calcium hydroxide-based composition is exposed to air having temperatures falling in the range from 2° C. to 50° C., preferably in the range from 15° C. to 50° C. and/or relative humidity levels falling in the range from 10% to 95%, more preferably in the range from 10% to 80%, preferably the range from 10% to 50% or 40% to 80%.

A21. The process according to any of the preceding Clauses, further comprising conditioning the collected calcium carbonate-based composition prior to the step of extracting at least some CO₂ from at least some of the collected calcium carbonate-based composition, preferably the step of conditioning comprising at least one of drying, grinding, milling, classifying, dehydroxylating or purifying the collected calcium carbonate-based composition, or any combination thereof, in particular the step of purifying comprising separating at least some of the un-reacted calcium hydroxide from the collected calcium carbonate-based composition, for instance via at least one of the following purification processes: air classification, leaching, pealing or floatation, or any combination thereof.

A22. The process according to any of the preceding Clauses, further comprising capturing at least a part of the CO₂ formed during the step of extracting at least some CO₂ from at least some of the collected calcium carbonate-based composition for subsequent sequestration and/or use.

B1. A calcium hydroxide-based composition characterized by:
a partial pore volume higher than 0.08 cm³/g, preferably equal to or higher than 0.09 cm³/g, in particular higher than 0.1 cm³/g, said pore volume being calculated according to the BJH method for a range of pores having a diameter be-tween 20 and 200 Å in accordance with standard DIN 66134 (February 1998 version);
preferably a BET specific surface area greater than 30 m²/g, preferably greater than 40 m²/g, and more preferably greater than 45 m²/g measured according to IS09277 standard (September 2010 version;
optionally wherein the difference between a total pore volume being calculated according to the BJH method for a range of pores having a diameter of between 20 and 1000 Å in accordance with standard DIN 66134 (February 1998 version) and said partial pore volume is equal to or higher than 0.06 cm³/g, preferably higher than 0.08 cm³/g;
wherein said composition is in the form of a composition with a water content above 35% by weight of said composition, preferably at most 85% by weight of at least of said composition, preferably said composition being a flowable composition such as a milk of lime or putty lime.

C1. A calcium hydroxide-based composition characterized by:
a partial pore volume higher than 0.08 cm³/g, preferably equal to or higher than 0.09 cm³/g, in particular higher than 0.1 cm³/g, said pore volume being calculated according to the BJH method for a range of pores having a diameter be-tween 20 and 200 Ain accordance with standard DIN 66134 (February 1998 version);
wherein the difference between a total pore volume being calculated according to the BJH method for a range of pores having a diameter of between 20 and 1000 Å in accordance with standard DIN 66134 (February 1998 version) and said partial pore volume is equal to or higher than 0.06 cm³/g, preferably higher than 0.08 cm³/g;
wherein said composition has a water content above 35% by weight of said composition, preferably at most 85% by weight of said composition.

C2. The calcium hydroxide-based composition according to Clause C1, wherein the calcium hydroxide-based composition is a flowable or malleable composition.

C3. A calcium hydroxide-based composition according to Clause C1 or C2, wherein said composition is a milk of lime or putty lime.

C4. The composition according to any of Clauses B1 or C1 to C3, wherein said composition reaches CO₂ content of at least 31% by weight, preferably at least 33% by weight, more preferably at least 37% by weight, in particular at least 41% by weight on a dry basis when carbonated under a test where four samples, namely a first, second, third and fourth sample of said composition are in con-tact with four predefined CO₂ enriched air compositions adapted to simulate an accelerated carbonatation in a weathering chamber, wherein each sample prior to the accelerated carbonatation is dried to reach a water content less than 1% by weight, said the CO₂ content being the lowest of the four CO₂ contents measured under the following conditions:
the first sample being in contact with CO₂ enriched air with a target temperature of 10° C., a target relative humidity of 75% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value;
the second sample being in contact with CO₂ enriched air with a target temperature of 30° C., a target relative humidity of 75% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value;
the third sample being in contact with CO₂ enriched air with a target temperature of 30° C., a target relative humidity of 60% and a target CO₂ concentration of 2000 ppmv, for 200 hours, wherein the temperature, the relative humidity and CO₂ content are regulated to remain in the range of +/−0.7° C., +/−5% RH and +/−10% around their corresponding target value.
the fourth sample in contact with CO₂ enriched air with a target temperature of 30° C., a target relative humidity of 45% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value.

D1. A calcium hydroxide-based composition characterized by:
a partial pore volume higher than 0.08 cm³/g, preferably equal to or higher than 0.09 cm³/g, in particular higher than 0.1 cm³/g, said pore volume being calculated according to the BJH method for a range of pores having a diameter of between 20 and 200 Å in accordance with standard DIN 66134 (February 1998 version);
preferably a BET specific surface area greater than 30 m²/g, preferably greater than 40 m²/g, and more preferably greater than 45 m²/g measured according to IS09277 standard (September 2010 version;
optionally wherein the difference between a total pore volume being calculated according to the BJH method for a range of pores having a diameter of between 20 and 1000 Å in accordance with standard DIN 66134 (February 1998 version) and said partial pore volume is equal to or higher than 0.06 cm³/g, preferably higher than 0.08 cm³/g;
   wherein said composition is in the form of shaped bodies, wherein the shaped bodies are selected from the group comprising pellets, granules, extrudates, 3D printings or compacts such as tablets or briquettes, preferably said composition having an envelope porosity of at least 20%, preferably at least 40%, in particular at least 50%.

D2. The composition according to Clause D1, wherein said composition reaches a CO₂ content of at least 31% by weight, preferably at least 33% by weight, more preferably at least 37% by weight, in particular at least 41% by weight on a dry basis when carbonated under a test where four samples, namely a first, second, third and fourth sample of said composition are in contact with four predefined CO₂ enriched air compositions adapted to simulate an accelerated carbonatation in a weathering chamber, wherein each sample prior to the accelerated carbonatation is milled to an average particle diameter less than 250 μm, said the CO₂ content being the lowest of the four CO₂ contents measured under the following conditions:
the first sample being in contact with CO₂ enriched air with a target temperature of 10° C., a target relative humidity of 75% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value;
the second sample being in contact with CO₂ enriched air with a target temperature of 30° C., a target relative humidity of 75% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value;
the third sample being in contact with CO₂ enriched air with a target temperature of 30° C., a target relative humidity of 60% and a target CO₂ concentration of 2000 ppmv, for 200 hours, wherein the temperature, the relative humidity and CO₂ content are regulated to remain in the range of +/−0.7° C., +/−5% RH and +/−10% around their corresponding target value.
the fourth sample in contact with CO₂ enriched air with a target temperature of 30° C., a target relative humidity of 45% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value.

D3. The composition according to any of Clauses D1 to D2, having a water content lower than or equal to 35% by weight of said composition, in particular of at least 5% by weight, preferably at least 10% by weight, and/or at most 20% by weight, preferably at most 15% by weight

D4. The composition according to any of Clauses B1, C1 to C4, or D1 to D3, having a weight fraction of Ca(OH)₂ of at least 80%, preferably at least 90% on a dry basis.

E1. A calcium hydroxide-based powder composition, said composition having the following features:
a partial pore volume equal to or higher than 0.09 cm³/g, in particular higher than 0.1 cm³/g, said pore volume being calculated according to the BJH method for a range of pores having a diameter of between 20 and 200 Å in accordance with standard DIN 66134 (February 1998 version);
preferably a BET specific surface area greater than 30 m²/g, preferably greater than 40 m²/g, and more preferably greater than 45 m²/g measured according to IS09277 standard (September 2010 version;
optionally wherein the difference between a total pore volume being calculated according to the BJH method for a range of pores having a diameter of between 20 and 1000 Å in accordance with standard DIN 66134 (February 1998 version) and said partial pore volume is equal to or higher than 0.06 cm³/g, preferably higher than 0.08 cm³/g;
a weight fraction of Ca(OH)₂ of at least 80%, preferably at least 90% on a dry basis;
   wherein said composition reaches a CO₂ content of at least 31% by weight, preferably at least 33% by weight, more preferably at least 37% by weight, in particular at least 41% by weight on a dry basis when carbonated under a test where four samples, namely a first, second, third and fourth sample of said composition are in contact with four predefined CO₂ enriched air compositions adapted to simulate an accelerated carbonatation in a weathering chamber, said the CO₂ content being the lowest of the four CO₂ contents measured under the following conditions:
      the first sample being in contact with CO₂ enriched air with a target temperature of 10° C., a target relative humidity of 75% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value;
   the second sample being in contact with CO₂ enriched air with a target temperature of 30° C., a target relative humidity of 75% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value;
   the third sample being in contact with CO₂ enriched air with a target temperature of 30° C., a target relative humidity of 60% and a target CO₂ concentration of 2000 ppmv, for 200 hours, wherein the temperature, the relative humidity and CO₂ content are regulated to remain in the range of +/−0.7° C., +/−5% RH and +/−10% around their corresponding target value.
   the fourth sample in contact with CO₂ enriched air with a target temperature of 30° C., a target relative humidity of 45% and a target CO₂ concentration of 2000 ppmv, for 200 hours, wherein the temperature, the relative humidity and CO₂ concentration are regulated to remain in the range of +/−0.7° C., +/−5% RH and +/−10% around their corresponding target value.

E2. The composition according to the preceding clause, having a water content lower than or equal to 35% by weight of said composition, in particular of at least 5% by weight, preferably at least 10% by weight, and/or at most 20% by weight, preferably at most 15% by weight.

E3. The composition according to any of Clauses E1 to E3, wherein particle diameter average of the calcium hydroxide-based powder composition is less than 100 μm, preferably less than 10 μm.

By “apparent density”, is meant the mass of a shaped body divided by its apparent (envelope) volume, i.e. the volume calculated from the outer dimensions of the shaped body. The shaped body density takes into account the volume of solid material of the shaped body and the volume of the closed and open pores of the particles forming the shape body as well as the voids intraparticle void(s) between the particulates of the shaped body. The apparent density is measured with a mercury picnometer. The apparent density by means of mercury picnometry is measured on 0.3 g of the shaped body or a fragment thereof according to the following procedure (source: catalogue of PMI-Porous Material Inc., and ‘Improved mercury picnometry for measuring accurate volumes of solid materials’, by S Yamagishi and Y Takahashi, published on IOPScience website):
sample cell is weighed,
sample is placed in the sample cell, cell and sample are weighed together. This gives accurately the weight of the sample,
mercury is added to the cell until saturation at atmospheric pressure,
the cell including the sample and the mercury is weighed,
the granule density of the sample is computed from the known weights, the volume of the cell, the volume of mercury in the cell with and without the sample being present, and the density of the mercury. The measurement is performed 3 times, and the average shaped body density is calculated.

In case the shaped body weighs more than 0.3 g, it is fractioned and one fragment thereof weighting 0.3 g serves for the test. The measurement is repeated with five shaped bodies. It should be stressed that Norm DIN 66134 (February 1998 version) is intended for the measurement of the pore volumes of particulates where a milling step is necessary to transform the composition (e.g. shaped body) into powder. To the contrary, a milling step is not performed before the mercury picnometry tests in order to preserve the intraparticle voids within the shaped bodies. These voids strongly influence the apparent density of a shaped body.

While the present disclosure has been illustrated and described in detail in the drawings and foregoing description, such illustration and description are to be considered illustrative or exemplary and not restrictive. Other variations to the disclosed embodiments can be understood and effected by those skilled in the art in practicing the claimed present disclosure, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

The foregoing description details certain embodiments of the present disclosure. It will be appreciated, however, that no matter how detailed the foregoing appears in text, the present disclosure may be practiced in many ways, and is therefore not limited to the embodiments disclosed. It should be noted that the use of particular terminology when describing certain features or aspects of the present disclosure should not be taken to imply that the terminology is being re-defined herein to be restricted to include any specific characteristics of the features or aspects of the present disclosure with which that terminology is associated.

1. A process for direct capture of carbon dioxide in air, the process comprising:
contacting a calcium hydroxide-based composition with air to capture CO₂ contained in the air by transforming at least some of the calcium hydroxide of the composition into calcium carbonate, forming a calcium carbonate-based composition;
collecting the calcium carbonate-based composition; and
extracting at least some CO₂ from at least some of the collected calcium carbonate-based composition;
wherein the calcium hydroxide-based composition has a partial pore volume equal to or higher than 0.09 cm³/g, the partial pore volume being calculated according to the BJH method for a range of pores having a diameter between 20 and 200 Å in accordance with standard DIN 66134 (February 1998 version); and
wherein the difference between a total pore volume being calculated according to the BJH method for a range of pores having a diameter of between 20 and 1000 Å in accordance with standard DIN 66134 (February 1998 version) and the partial pore volume is equal to or higher than 0.06 cm³/g.

2. The process according to claim 1, wherein the calcium hydroxide-based composition comprises a malleable or flowable composition having a water content above 35% by weight.

3. The process according to claim 2, further comprising:
providing a support for the calcium hydroxide-based composition, the support being stationary or in motion relative to a reference frame, the support comprising a plate, a bucket, a pile, a shelf, a tray, a filter media, a cartridge, a grate, a tile, a wall, a brick, a bead, a carbonated product, a ground, or a net; and
spreading or coating the calcium hydroxide-based composition on the support to form a layer.

4. The process according to claim 2, further comprising obtaining the malleable or flowable composition by mixing a calcium hydroxide-based powder composition with water or by slaking quicklime.

5. The process according to claim 1, wherein the calcium hydroxide-based composition is in the form of shaped bodies.

6. The process according to claim 5, wherein the shaped bodies are selected from the group consisting of pellets, granules, extrudates, 3D printings, and compacts.

7. The process according to claim 5, further comprising shaping a malleable or flowable composition having a water content above 35% by weight into the shaped bodies, said malleable or flowable composition being obtained by mixing a calcium hydroxide-based powder composition with water or by slaking quicklime.

8. The process according to claim 7, further comprising forming ridges on the shaped bodies or curing the shaped bodies using CO₂.

9. The process according to claim 7, further comprising, prior to the shaping of the shaped bodies, mixing the malleable or flowable composition with one or more element selected from the group consisting of structural elements, an additive, and water.

10. The process according to claim 5, further comprising shaping a calcium hydroxide-based powder composition into the shaped bodies.

11. The process according to claim 10, further comprising forming the calcium hydroxide-based powder composition by mixing a calcium hydroxide powder with one or more element selected from the group consisting of structural elements, an additive, and water.

12. The process according to claim 5, further comprising:
providing a support for the calcium hydroxide-based composition, the support being stationary or in motion relative to a reference frame, the support being selected from the group consisting of a trommel, a plate, a bucket, a pile, a shelf, a tray, a filter media, a cartridge, a grate, a tile, a wall, a brick, a carbonated product, a net, a ground, a basket, and a gabion; and
contacting the calcium hydroxide-based composition with air in a packed bed or in a fluidized bed.

13. The process according to claim 1, wherein the calcium hydroxide-based composition comprises a calcium hydroxide-based composition having a water content lower than or equal to 35% by weight, the composition being in the form of a powder.

14. The process according to claim 13, further comprising:
providing a support for the calcium hydroxide-based composition, the support being stationary or in motion relative to a reference frame, the support being selected from the group consisting of a trommel, a plate, a bucket, a pile, a shelf, a tray, a filter media, a cartridge, a grate, a tile, a wall, a brick, a carbonated product, a ground, and a net; and
applying the composition on the support to form a layer.

15. The process according to claim 1, wherein contacting the calcium hydroxide-based composition with the air further comprises:
adjusting at least one of:
an air flow rate,
a calcium hydroxide-based composition flow rate,
a calcium hydroxide-based composition residence time,
a calcium hydroxide-based composition inventory,
an air temperature,
an air relative humidity,
an air absolute humidity, and
an absolute water content inside the calcium hydroxide-based composition,
by controlling the CO₂ capture in air using at least one of:
an air flow control element,
a calcium hydroxide-based composition flow control element,
a humidifier,
a cooler, and
a heater.

16. The process according to claim 1, further comprising:
conditioning the collected calcium carbonate-based composition prior to extracting at least some CO₂ from at least some of the collected calcium carbonate-based composition,
wherein conditioning includes one or more of drying, grinding, milling, classifying, dehydroxylating, or purifying the collected calcium carbonate-based composition.

17. The process according to claim 1, wherein the collection of the calcium carbonate-based composition takes place when said composition reaches a CO₂ content of at least 31% by weight on a dry basis, and wherein contacting the composition with air includes exposing the calcium hydroxide-based composition to air having temperatures of 15° C. to 50° C. or relative humidity levels of 40% to 80%.

18. The process according to claim 1, wherein extracting at least some CO₂ from at least some of the collected calcium carbonate-based composition is performed via calcination, electrolysis, or both calcination and electrolysis.

19. The process according to claim 1, wherein the calcium hydroxide-based composition has a partial pore volume higher than 0.1 cm³/g.

20. The process according to claim 1, wherein the difference between a total pore volume being calculated according to the BJH method for a range of pores having a diameter of between 20 and 1000 Å in accordance with standard DIN 66134 (February 1998 version) and said partial pore volume is higher than 0.08 cm³/g.
